(19) United States
(12) Patent Application Publication
(10) Pub. No.: US 2013/0025950 A1
(43) Pub. Date: Jan. 31, 2013

(54) ELECTRIC CART

(71) Applicant: Dennis Brandon, Brentwood, TN (US)

(72) Inventor: Dennis Brandon, Brentwood, TN (US)

(21) Appl. No.: 13/359,284

(22) Filed: Jan. 26, 2012

Related U.S. Application Data
(60) Provisional application No. 61/436,333, filed on Jan. 26, 2011.

(51) Int. Cl. B60K 1/00; B60S 5/06; B60K 1/04

(52) U.S. Cl. 180/65.1

(57) ABSTRACT

An electric cart with one or more lightweight, quick-change batteries or battery packs mounted on the cart frame. The cart body has battery pack access openings to provide easy access to remove and replace battery packs during racing operations. The batteries are easily removed and replaced so that a particular cart can be “refueled” in a matter of seconds. The batteries being removed are placed on a charger, and can be placed back into service relatively quickly. Lithium Ion batteries may be used for the battery packs. The electric cart also may include electrically-adjustable pedals and seats.

This application claims benefit of and priority to U.S. Provisional Application No. 61/436,333, filed Jan. 26, 2011, and is entitled to that filing date for priority. The specification, figures and complete disclosure of U.S. Provisional Application No. 61/436,333 are incorporated herein by specific reference for all purposes.

### FIELD OF INVENTION

This invention relates to an electric-powered cart. More particularly, this invention relates to an electric-powered cart for racing with easily changeable battery packs, and electrically adjustable seat and pedal positions.

### BACKGROUND OF THE INVENTION

Cart racing, also known as kart racing, is becoming a popular sport and recreational activity. Carts with internal combustion engines are well known in the art, but the exhaust fumes can accumulate and cause problems when used indoors or in large numbers. In addition, the noise levels are very high.

Examples of carts and racing carts are disclosed in U.S. Pat. Nos. 6,170,596; 6,267,388; 6,749,039; and 7,000,727; the specifications, drawings and disclosures of which are incorporated herein by specific reference for all purposes.

Electric powered carts have been developed to address the exhaust and noise issues, but in order to supply sufficient motive force for a racing cart used in commercial-scale operations, four or more large lead-acid batteries are used per cart. These batteries typically require recharging after each round of racing. While these batteries can be recharged, the cart is out of operation during the process. In most cases, the charge time is nearly twice the run time which results in needing three sets of carts if continual operation is expected. The cost of an electric cart is more than the cost of an internal combustion, gas-powered cart, and if three sets are required, the extra costs for carts is prohibitive in many situations. In addition, due to the long charging time, three sets of battery chargers are required.

### SUMMARY OF INVENTION

In various exemplary embodiments, the present invention comprises an electric cart with one or more batteries or battery packs mounted on the cart frame. The cart body has battery pack access openings to provide easy access to remove and replace battery packs during operations. The access openings may be open or covered, in whole or in part, such as with a hinged cover that is easily opened (or removed).

The batteries are easily removed and replaced so that a particular cart can be “refueled” in a matter of seconds. The batteries being removed are placed on a charger, and can be placed back into service relatively quickly. Thus, a cart racing operation using the cart of the present invention can reduce the number of electric carts in its fleet by approximately 50% to 66%. Only one-third to one-half of the number of carts are needed because the carts themselves do not need to be taken out of active use to recharge, as in prior art operations.

Lithium Ion batteries may be used in one embodiment of the present invention. Lithium-Iron-Phosphate batteries (LiFePO₄) that have comparable voltage and Ahr ratings to lead acid batteries weigh less than 50% of a lead acid battery, have a longer life, and re-charge more quickly. By using LiFePO₄ batteries, a closer ratio of run time to charge time can be achieved for a commercial operation.

The use of quick-change LiFePO₄ battery packs results in a cart racing operation only needing one set of electric carts, one set of battery chargers, and two sets of batteries or battery packs. One set of battery packs would be removed and charging separately, while the cart is operating with the other set of battery packs. When the race is over and the driver returns to the pits, the battery packs are easily changed in 10 to 30 seconds or less, while the drivers are unloading and loading into the carts.

A standalone LiFePO₄ battery cell is normally 3.0 to 3.2 volts. Multiple cells can be incorporated into specialized packages (battery packs). To balance the weight of the cart and minimize the weight of the LiFePO₄ battery packs, in one exemplary embodiment, two 24-volt LiFePO4 batteries in series are used. Each battery pack includes eight LiFePO₄ cells. Based on this configuration, the weight of each battery pack will be less than approximately 35 pounds.

In one embodiment of the present invention, the battery packs incorporate a male/female type connection. A male connector on the battery pack is inserted into a female connector on the cart's mount or holder for the battery pack. A similar connector is used on the battery charger. In an alternative embodiment, two or more male connectors may be used with corresponding female connectors for each battery pack. Further, the connector types may be reversed (e.g., male connectors on the mount or holder, female connectors on the battery packs). Other forms of connectors, such as wires, plugs, or simple metal contacts, also may be used.

This allows the battery packs to quickly and easily connect to a mating connector on the cart and/or the battery charger. The battery pack is inserted, then clamped or locked into place for operation, such as by quick-release tabs, holders, straps or bars. The quick-release tabs or locks may be separate or integrated with the connectors. In one embodiment, spring-loaded pivoting arms or levers may be incorporated as part of the handles on the battery packs, which are then used to engage a slot or holder on the cart frame. The operation is reversed to remove the battery pack. The battery packs may include hand holds or handles for ease in handling.

Lightweight batteries other than LiFePO4 batteries may also be used, including, but not limited to, other forms of Lithium-Ion batteries.

In yet another exemplary embodiment, the cart of the present invention includes electrically-adjustable pedals and seats. An electric seat adjustment mechanism comprises an electric motor or actuator that moves or rotates an arm, piston, lever or screw rod to cause the seat to move forward or backward. The movement may be controlled by a switch, button, lever, control pad or screen, or similar mechanism, so that the driver of the cart may easily move the seat forward or backward as desired to any point along a continuum between the maximum and minimum points.

Similarly, an electric pedal adjustment mechanism moves the pedal assembly (including the accelerator pedal and brake pedal). In this embodiment, an electric motor or actuator moves or rotates an arm, piston, lever or screw rod to cause the pedal assembly to move forward or backward. The movement may be controlled by a switch, button, lever, control pad or screen, or similar mechanism, so that the driver of the cart may easily move the pedal assembly forward or backward as desired to any point along a continuum between the maximum and minimum points. In yet another embodiment, separate mechanisms are used for each pedal, so that the accelerator pedal and the brake pedal may be adjusted separately.

### BRIEF DESCRIPTION OF THE DRAWINGS

FIG. 1 shows a view of a cart in accordance with an embodiment of the present invention.

FIG. 2 shows another view of a cart in accordance with an embodiment of the present invention.

FIG. 3 shows another view of a cart in accordance with an embodiment of the present invention.

FIG. 4 shows a detailed view of a battery attachment mechanism from FIG. 1.

FIG. 5 shows a detailed view of an adjustable seat mechanism from FIG. 1.

FIG. 6 shows a detailed view of an adjustable pedal mechanism from FIG. 1.

### DETAILED DESCRIPTION OF EXEMPLARY EMBODIMENTS

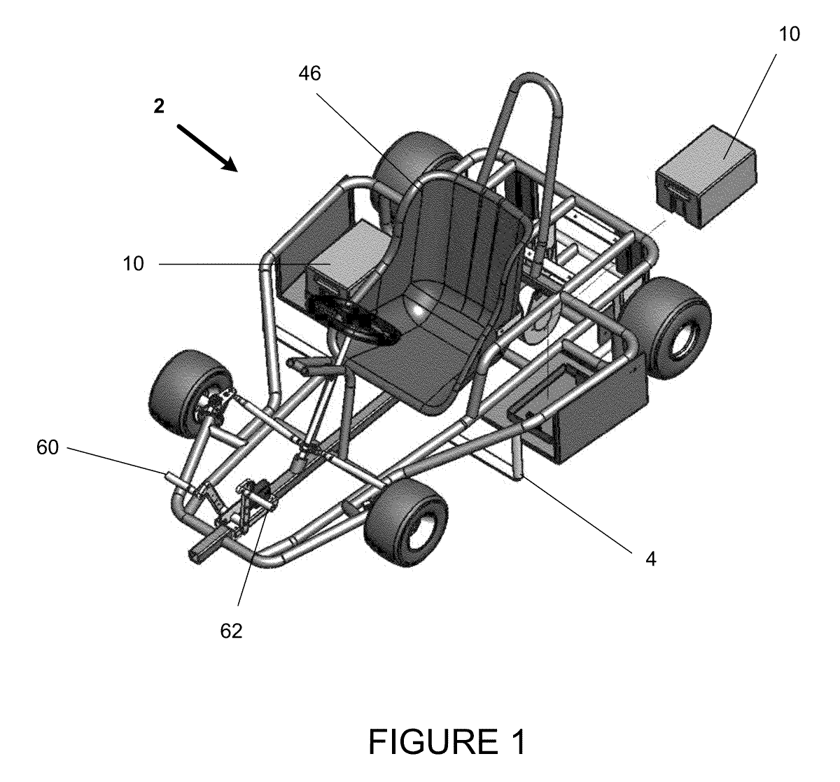

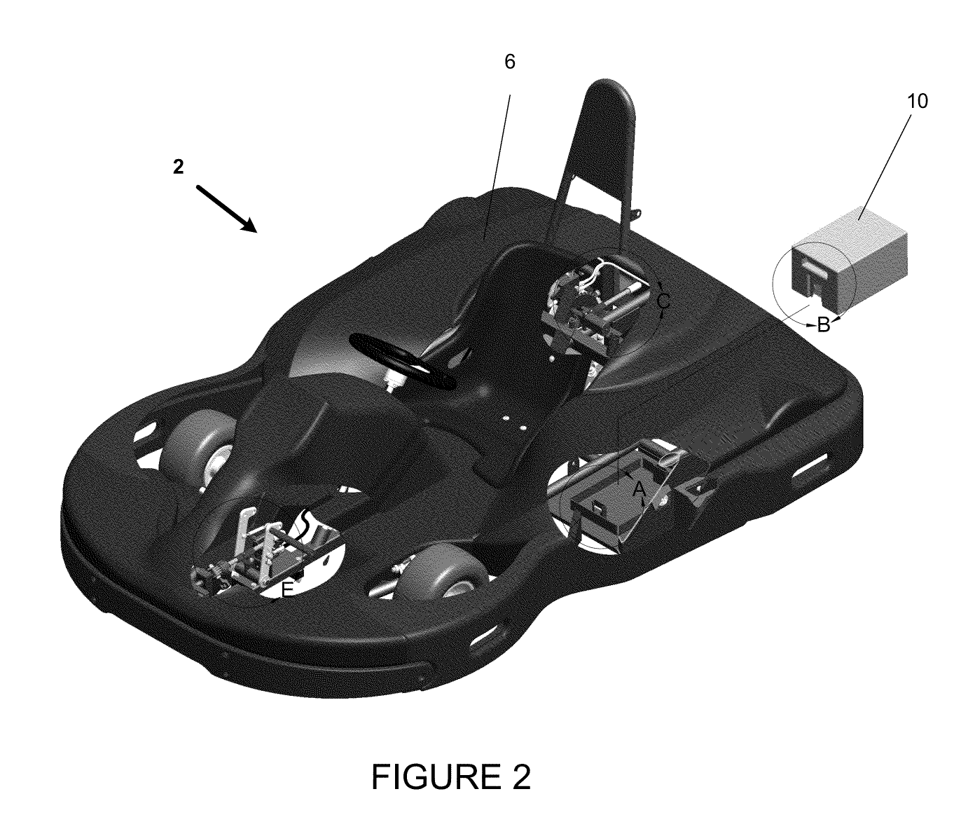

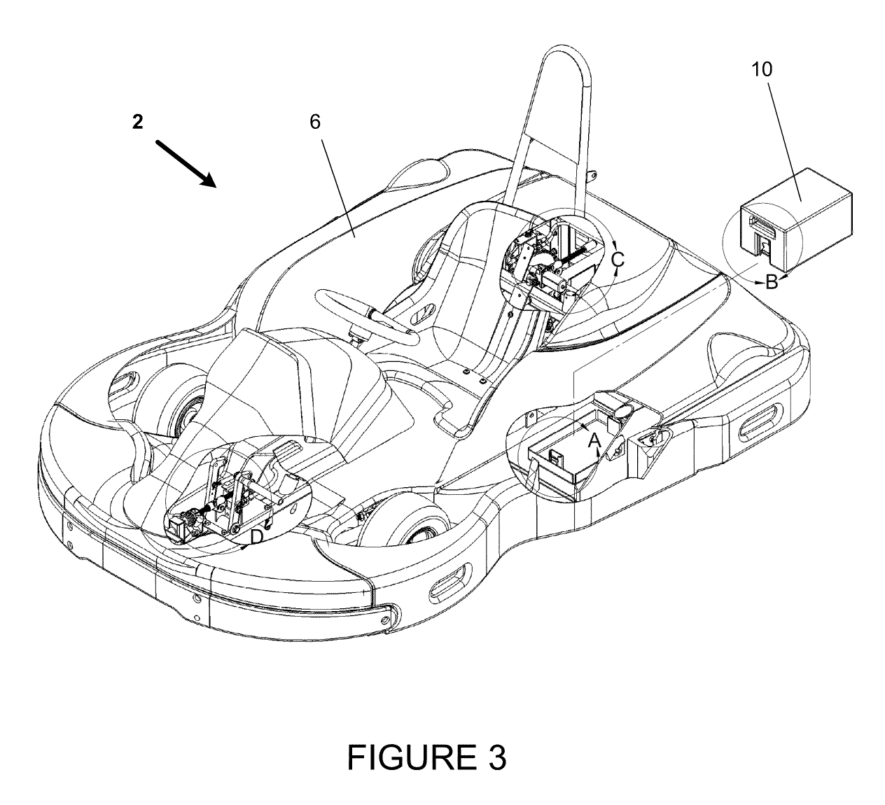

In various exemplary embodiments, as shown in FIGS. 1 through 6, the present invention comprises an electric cart 2 with one or more batteries or battery packs 10. FIG. 1 shows two battery packs 10 in place on opposite sides of a cart frame 4 (i.e., with the cart body 6 removed), while FIGS. 2 and 3 shows the cart with the cart body 6 mounted on the frame 4. The cart body has battery pack access openings 8 to provide easy access to remove and replace battery packs 10 during operations. The access openings 8 may be open, as shown, or may be covered in whole or in part, such as with a hinged cover that is easily opened (or removed).

The batteries 10 are easily removed and replaced as described below, so that a particular cart can be “refueled” in a matter of seconds. The batteries being removed are placed on a charger, and can be placed back into service relatively quickly. Thus, a cart racing operation using the cart of the present invention can reduce the number of electric carts in its fleet by approximately 50% to 66%. Only one-third to one-half of the number of carts are needed because the carts themselves do not need to be taken out of active use to recharge, as in prior art operations.

Most electric carts operate with a 48 or 72 volt system. This is achieved by using multiple lead-acid 12-volt batteries connected in series. For example, a 48-volt system would require four 12-volt batteries connected in series. Most electric carts have two batteries on each side of the cart to balance the weight of the cart, although a single battery may also be used (often placed along or near the center line of the cart for balance purposes). To connect the four batteries in series normally requires seven battery cables. On average, these batteries weigh 40 pounds each, which results in approximately 160 total pounds.

Lithium Ion batteries may be used in one embodiment of the present invention. Lithium-Iron-Phosphate batteries (LiFePO₄) that have comparable voltage and Ahr ratings to lead acid batteries weigh less than 50% of a lead acid battery, have a longer life, and re-charge more quickly. By using LiFePO₄ batteries, a closer ratio of run time to charge time can be achieved for a commercial operation. However, simply using LiFePO₄ batteries in current carts would still require a minimum of two sets of carts for continual operation.

The use of quick-change LiFePO₄ battery packs results in a cart racing operation only needing one set of electric carts, one set of battery chargers, and two sets of batteries or battery packs. One set of battery packs would be removed and charging separately, while the cart is operating with the other set of battery packs. When the race is over and the driver returns to the pits, the battery packs are easily changed in 10 to 30 seconds or less, while the drivers are unloading and loading into the carts.

A stand alone LiFePO₄ battery cell is normally 3.0 to 3.2 volts. Multiple cells can be incorporated into specialized packages (battery packs). To balance the weight of the cart and minimize the weight of the LiFePO₄ battery packs, in one exemplary embodiment, two 24-volt LiFePO4 batteries in series are used. Each battery pack includes eight LiFePO₄ cells. Based on this configuration, the weight of each battery pack will be less than approximately 35 pounds.

The weight, number of batteries, and cabling connections of standard lead acid batteries makes them prohibitive for a quick-change configuration. Even if the cabling and connection for lead acid batteries could be solved for a quick-change scenario, due to the longer charge time it would still require at least two extra sets of batteries and battery chargers.

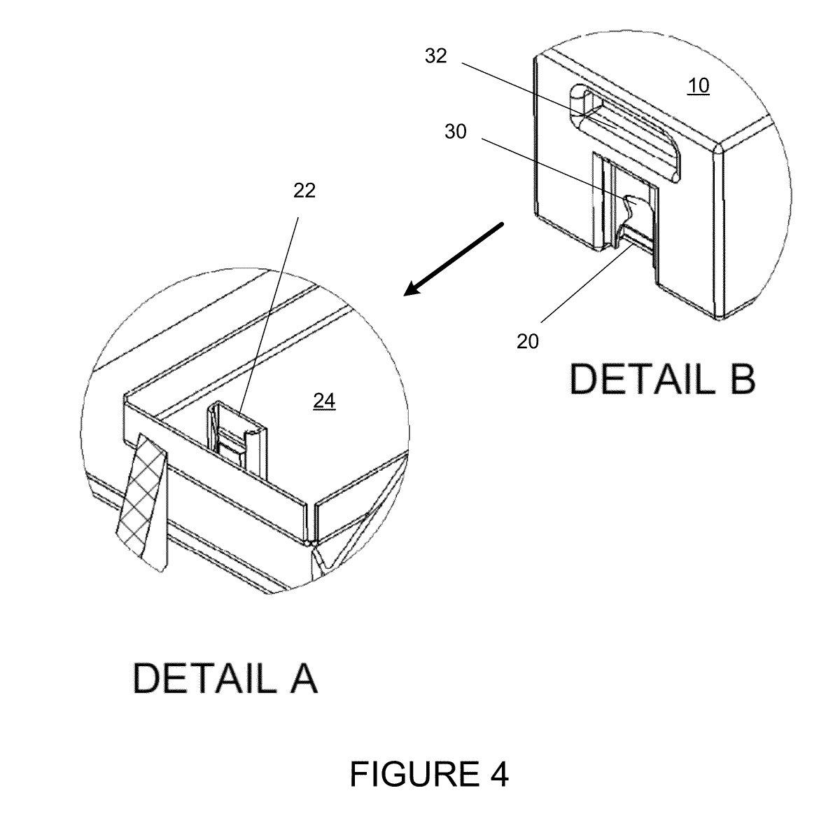

In one embodiment of the present invention, as seen in FIG. 4, the LiFePO₄ battery packs 10 incorporate a male/female type connection. A male connector 20 on the battery pack is inserted into a female connector 22 on the cart's mount or holder 24 for the battery pack. A similar connector is used on the battery charger. In an alternative embodiment, two or more male connectors may be used with corresponding female connectors for each battery pack. Further, the connector types may be reversed (e.g., male connectors on the mount or holder, female connectors on the battery packs). Other forms of connectors, such as wires, plugs, or simple metal contacts, also may be used.

This allows the battery packs to quickly and easily connect to a mating connector on the cart and/or the battery charger. The battery pack is inserted, then clamped or locked into place for operation, such as by quick-release tabs 30, holders, straps or bars. The quick-release tabs or locks may be separate or integrated with the connectors. In one embodiment, spring-loaded pivoting arms or levers may be incorporated as part of the handles on the battery packs, which are then used to engage a slot or holder on the cart frame. The operation is reversed to remove the battery pack. The battery packs may include hand holds or handles 32 for ease in handling.

Lightweight batteries other than LiFePO4 batteries may also be used, including, but not limited to, other forms of Lithium-Ion batteries.

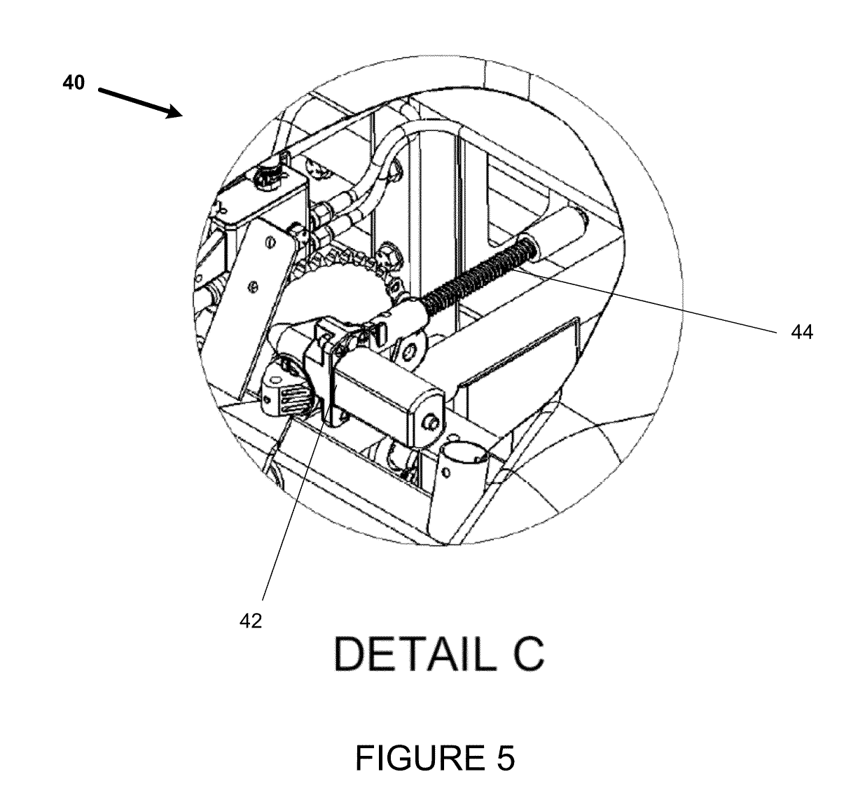

In yet another exemplary embodiment, the cart of the present invention includes electrically-adjustable pedals and seats. FIG. 5 shows a detailed view of an exemplary embodiment of an electric seat adjustment mechanism 40. In this embodiment, an electric motor or actuator 42 moves or rotates an arm, piston, lever or screw rod 44 to cause the seat 46 to move forward or backward. The movement may be controlled by a switch, button, lever, control pad or screen, or similar mechanism, so that the driver of the cart may easily move the seat forward or backward as desired to any point along a continuum between the maximum and minimum points.

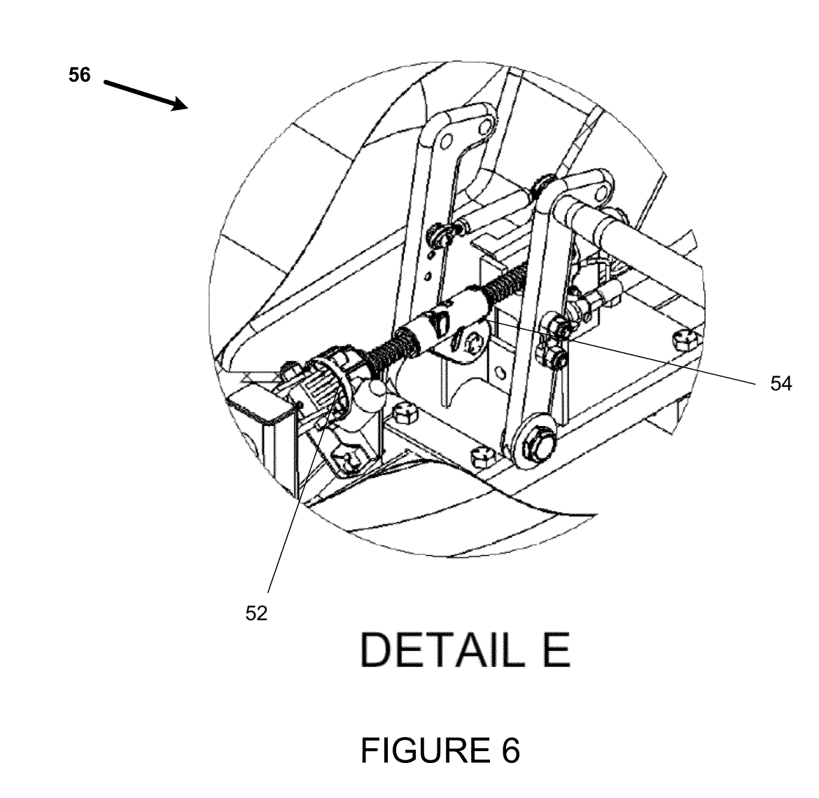

Similarly, FIG. 6 shows a detailed view of an exemplary embodiment of an electric pedal adjustment mechanism 50 that moves the pedal assembly 56 (including the accelerator pedal 60 and brake pedal 62). In this embodiment, an electric motor or actuator 52 moves or rotates an arm, piston, lever or screw rod 54 to cause the pedal assembly 56 to move forward or backward. The movement may be controlled by a switch, button, lever, control pad or screen, or similar mechanism, so that the driver of the cart may easily move the pedal assembly forward or backward as desired to any point along a continuum between the maximum and minimum points. In yet another embodiment, separate mechanisms are used for each pedal, so that the accelerator pedal and the brake pedal may be adjusted separately.

The combination of the seat and pedal adjustment mechanisms allows the driver to quickly and easily make adjustments in a cart at the start of each race without the use of seat inserts, seat boosters, pedal blocks or similar devices that can shift or move while the cart is being driven, thereby increasing safety and comfort. In particular, the combination allows a single cart to more easily accommodate both small individuals (e.g., children) and tall individuals, either by moving the seat forward and pedals back, or moving the pedals forward and the seat back, thereby eliminating the need to have special carts for small or tall drivers.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An electric-powered go-cart, comprising:
a cart frame with an electric motor mounted thereon; and
one or more lightweight battery packs to provide power to the electric motor, wherein the battery pack or packs are removably mounted on the cart frame.

2. The go-cart of claim 1, further comprising an electrically-adjustable pedal assembly mounted on the cart frame, wherein the pedal assembly can be moved to any point along a continuum between a maximum point and a minimum point.

3. The go-cart of claim 1, further comprising an electrically-adjustable seat mounted on the cart frame, wherein the seat can be moved to any point along a continuum between a maximum point and a minimum point.

4. The go-cart of claim 1, wherein there are two battery packs mounted on opposite sides of the cart frame.

5. The go-cart of claim 1, wherein each battery pack can be removed and replaced within 30 seconds.

6. The go-cart of claim 1, wherein each battery pack weighs 35 pounds or less.

7. The go-cart of claim 1, wherein the battery pack or packs comprise Lithium Ion batteries.

8. The go-cart of claim 7, wherein each battery pack comprises two 24-volt batteries in series.

9. The go-cart of claim 7, wherein the battery pack or packs comprise LiFePO4 batteries.

10. The go-cart of claim 1, further where the battery pack or comprise an electrical connector adapted to mate with a corresponding electrical connector on the cart frame.

11. The go-cart of claim 1, further comprising a battery mount on the cart frame for each battery pack.

12. A system for managing a racing cart operation, comprising the steps of:
providing a set of electric-powered racing carts for use in a race, each cart comprising a pair of quick-change battery packs,
wherein the battery packs can be quickly removed and replaced by charged battery packs between races without removing carts from operation.

13. The system of claim 12, wherein the racing cart operation comprises a single set of carts, a single set of battery pack rechargers, and two sets of battery packs.

14. The system of claim 12, further wherein each of said carts comprise a cart frame with an electric motor mounted thereon, and said battery packs are removably mounted on the respective cart frame.

15. The system of claim 14, further comprising an electrically-adjustable pedal assembly mounted on the cart frame, wherein the pedal assembly can be moved to any point along a continuum between a maximum point and a minimum point.

16. The system of claim 14, further comprising an electrically-adjustable seat mounted on the cart frame, wherein the seat can be moved to any point along a continuum between a maximum point and a minimum point.

17. The system of claim 14, wherein the battery packs mounted on opposite sides of the cart frame.

18. The system of claim 12, wherein each battery pack can be removed and replaced within 30 seconds.
